(19) United States
(12) Patent Application Publication
(10) Pub. No.: US 2003/0196259 A1
(43) Pub. Date: Oct. 23, 2003

(54) Sanitary device

(76) Inventor: Juergen Gross, Ortenberg (DE)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/296,083

(22) PCT Filed: Feb. 28, 2002
(86) PCT No.: PCT/EP02/02158

(30) Foreign Application Priority Data
Mar. 22, 2001 (DE) 101 14 356.7

(51) Int. Cl. A61H 33/04

(52) U.S. Cl. 4/541.6

(57) ABSTRACT

In a sanitary device with at least one installed water outlet nozzle, in which the sanitary device has a front wall with a front side facing the user, having at least one opening forming with the front side a front edge and with at least one water outlet nozzle fixed by retaining means to a holder of the sanitary device, the retaining means engage behind the front side (19) of the front wall (12) and the front edge (20) of the opening (15) is free from retaining means.

The sanitary device can have a holder forming a type of set back front part.

### FIELD OF APPLICATION AND PRIOR ART

The invention relates to a sanitary device with at least one installed water outlet nozzle. The sanitary device has a front wall with a front side facing the user on which is constructed at least one opening forming with said front side a front edge, at least one water outlet nozzle being fixed by retaining means to a holder of the sanitary device.

Such sanitary devices with water outlet nozzles are widely used throughout the entire sanitary field, e.g. as complete showers, whirlpools and the like. In the case of conventional sanitary fittings the water outlet nozzle is clamped to the front wall and at least the retaining means, e.g. a flange, projects over the front side of the front wall. This does not have a very elegant effect and also suffers from technical disadvantages, e.g. the user could become caught on the retaining means and tear the same together with the water outlet nozzle out of the front wall.

### PROBLEM AND SOLUTION

The problem of the invention is to provide a sanitary device of the aforementioned type, which has at least one easily and rapidly installable water outlet nozzle and in particular avoids the disadvantages of the aforementioned prior art.

This problem is solved by a sanitary device having the features of claim 1. Further developments of the invention are provided in the subclaims.

The sanitary device according to the invention is characterized in that the retaining means engage behind the front side of the front wall and the front edge of the opening is free from retaining means.

Unlike in the case of conventional sanitary devices, there is no engaging of the retaining means over the front side of the front wall, so that in particular with comfort showers and the like an elegance hitherto unattainable can be brought about in the vicinity of the water outlet nozzles. A contact between the user and the retaining means and therefore a possible unintended release of the water outlet nozzle is prevented by this.

Sanitary devices according to the invention are, as stated, e.g. multifunction or complete showers, walls of shower cabins or columns, the bottom or basin edge of a whirlpool and the like. water outlet nozzles can be showers, particularly lateral showers, bubble nozzles, steam nozzles and the like.

In particularly preferred manner, despite its retaining means engaging behind the front side of the front wall, the water outlet nozzle is preferably constructed so as to be insertable through the opening from the front. This combines the advantage of time-saving front fitting and the already indicated advantage of frontal invisibility of the retaining means.

In particularly preferred manner the holder, on which engage the retaining means, is set back with respect to the front side of the front wall. Thus, the holder can form a type of set back front surface. This makes it possible to secure the water intake nozzle in the opening in three different positions relative to the front side of the front wall. It is also possible to install the water outlet nozzle set back with respect to the front side of the front wall. It is also possible for the water outlet nozzle to project from the opening. However, preferably the water outlet nozzle is installed in a substantially front-flush manner.

One possibility of the construction of the holder is to shape it in one piece on the front wall. This economizes separate holding components, which firstly have to be fitted to the front wall. Preferably the entire front wall is produced by continuous casting. Thus, in simple manner, in the longitudinal direction the front wall has a through, uniform material thickness. The holder can be shaped at the same time. The opening through which the water outlet nozzle is introduced into the front wall can also be formed by a bore in the continuous casting, which can be simply and rapidly implemented.

In particularly preferred manner a holder is provided which retains the water outlet nozzle in the opening so that it cannot twist and slide. This is intended to prevent sliding in both the longitudinal and transverse directions of the front wall, together with a twisting in the opening. The holders can e.g. be constituted by two angle members fixed on both sides of the opening to the rear of the front wall, which taper the opening in the sliding in direction and which prevent the water outlet nozzle from being forced through by the holder. In order to prevent transverse and/or longitudinal sliding, on the side legs of the angle member are preferably fitted circular recesses. Another possibility for the construction of the holder is provided by a long angle member, which is also fitted to the rear of the front wall and whose side leg is located spaced from the front side behind the opening. A passage can be used for preventing longitudinal and/or transverse sliding, said passage being made through a rear part of the water outlet opening.

It is possible for the holder to form with the front wall a chamber. The chamber can be closed on at least one side in the lateral direction of the front wall. However, preferably the chamber is closed on both sides in the lateral direction, so that no water or steam can penetrate to the rear engaging retaining means. The chamber can pass over the entire length of the front wall and at both ends can form an open termination with the front wall. This is particularly favourable if the chamber is also shaped during continuous casting, i.e. the chamber forms part of the casting and does not have to be produced by further machining steps. The open terminations of the chamber are preferably covered or lined, so that no water or steam can penetrate the chamber.

In the case of many sanitary devices the front wall is curved perpendicular to its longitudinal direction, e.g. with shower columns, etc. However, preferably and despite the curved front wall, the rear wall of the chamber is planar, so that it is possible to have a precise and rapid fixing of the water outlet nozzle in the opening by retaining means which can be acquired as standard parts. With a curved rear wall the retaining means would have to be special parts, which would be correspondingly expensive.

According to a further development of the invention the holder is constructed as an abutment to which can be engaged the water outlet nozzle and is used for fixing the water outlet nozzle in the opening.

The abutments are preferably constituted by narrow, preferably circular edge portions of the holder, whose diametral spacing is smaller than the diameter of the opening on the front side of the front wall. The abutment can e.g. be formed by the edge of an opening in the rear wall of the chamber.

Preferably the water outlet nozzle is exclusively fixed to the holder located behind the front wall.

To fix the water outlet nozzle in the opening, preferably to the abutment, are provided retaining means, which are preferably constituted by a flange on the water outlet nozzle and a counterpart and which embrace on either side the holder, particularly the abutment. Thus, in the sliding in direction, the flange on the water outlet nozzle can be fixed to a projecting length of the holder, particularly the rear wall of the chamber and is secured by the counterpart to the abutment. The counterpart can be a nut, which is screwed onto a thread on the rear part of the water outlet nozzle and which is supported on the back of the holder. However, it is also conceivable to secure the water outlet nozzle by a tensioning element, e.g. a spring. For example the counterpart can be constructed as a type of collar, which is fastened to the water outlet nozzle and which is e.g. shaped in one piece. On the collar can be shaped springs, which face one another, e.g. diametral to the centre axis of the opening. In order to be able to secure the water outlet nozzle the springs can engage behind a flange constructed on the holder and in particular also shaped thereon in one piece. It is also conceivable to use a separate spring in the manner of a spring clip and to use the collar solely as a centring element. The separate spring could also engage behind a flange on the holder and be supported on the collar, so that the latter is supported on the holder and fixes the water outlet nozzle.

To prevent twisting or turning of the water outlet nozzle, on the holder can be constructed at least one locking element, which takes over this task. The locking element can e.g. be a groove, which cooperates with a complimentary stud on the water outlet opening. Particular preference is given to two facing grooves diametral to the centre axis of the opening at the holder passage. However, other locking elements are conceivable, e.g. springs on the holder, which lock in corresponding spring receptacles on the water outlet nozzle.

According to a further development of the invention the water outlet can have a covering, which is preferably constructed in such a way that it terminates substantially flush with the front side of the front wall. A preferred covering is e.g. a solid flange. in order to prevent a tilting of the covering with the front edge of the opening, the latter can have a circumferential shadow gap. The covering can be fixed to the water outlet opening. However, it can also be connected in one piece with the water outlet opening. In particularly preferred manner the covering, particularly the solid flange, is prevented from turning together with the water outlet nozzle. For example pins can be used for this purpose and engage in grooves on the holder.

The described and further features of the invention can be gathered from the following description of preferred embodiments in conjunction with the subclaims and drawings. The individual features can be implemented singly or in random combination.

### DESCRIPTION OF THE DRAWINGS

An embodiment of the invention is illustrated in the drawings, wherein show:

FIG. 1 A cross-section through the front wall of the sanitary device according to the invention in the unequipped state.

FIG. 2 On the left-hand side, a front view of part of the front wall with the opening and on the right-hand side a three-dimensional view of the front wall and the opening.

FIG. 3 A broken away longitudinal section through the front wall in the equipped state.

FIG. 4 A cross-section through the front wall in the equipped state.

The subsequently described embodiment of the sanitary device 11 according to the invention is to be explained by means of a multifunction shower equipped with side shower elements. However, other sanitary devices are conceivable, e.g. a column shower equipped with side shower elements, a whirlpool equipped with bubble nozzles and/or massage nozzles, a steam chamber equipped with steam nozzles, etc.

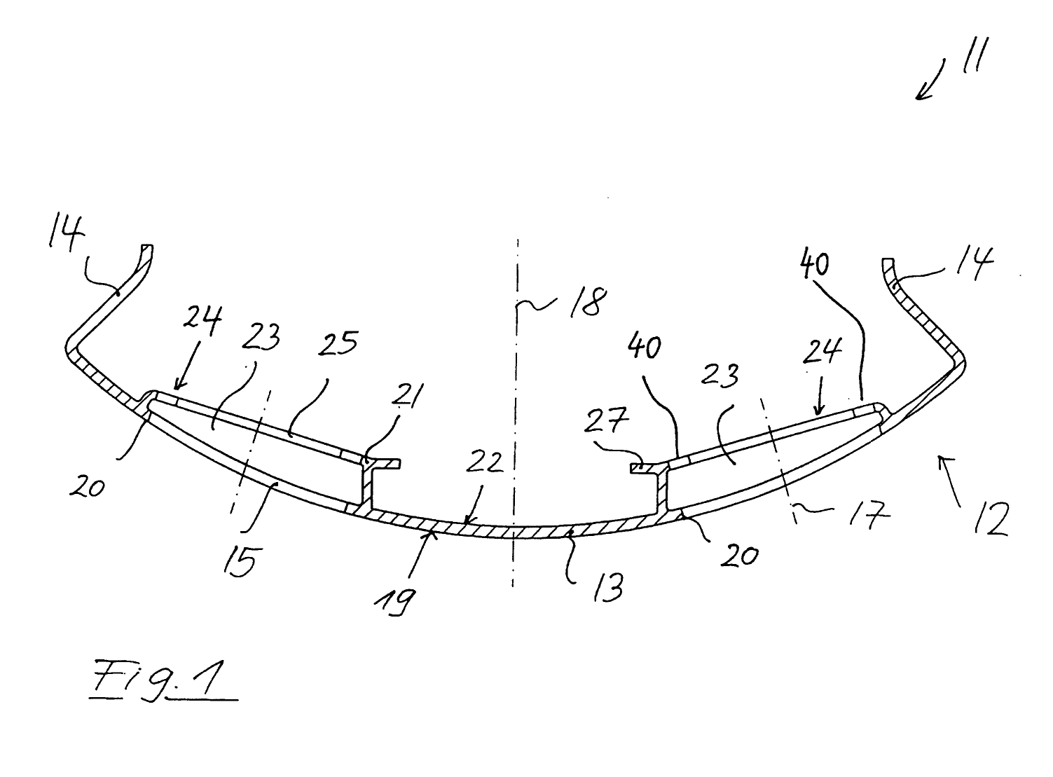

The embodiment of a sanitary device 11 according to the invention shown in FIGS. 1 to 4 comprises a front wall 12, which is shown in the unequipped state in FIG. 1.

The front wall 12 is the front panel of a multifunction shower. The front wall 12 is a continuous casting, particularly of aluminium. The aluminium can be anodized and/or painted in order to improve its optical effect. However, other manufacturing methods for the front wall and materials are conceivable, e.g. high-grade steel, plastic, etc. In the embodiment described the front wall 12 has a circular segmentally curved front portion, to which is connected on either side and at an angle of approximately 80 to 90° in each case a side edge portion 14. The front wall 12 has a constant material thickness over its entire length. However, the front wall can also have other geometries. It can e.g. terminate in planar manner or can be inwardly curved, such as is e.g. the case with whirlpool basin edges.

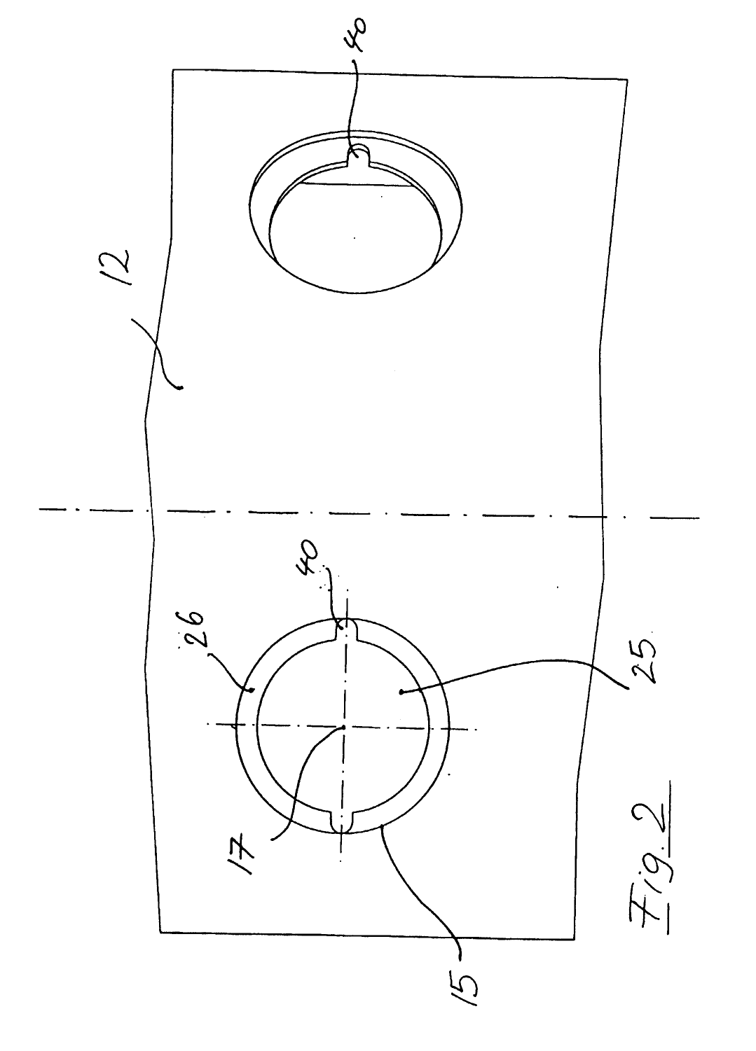

On the front portion 13 of the front wall 12 are formed openings 15 for the insertion of a water outlet nozzle 16, to be described in greater detail hereinafter. The openings 15 can be positioned in such a way that their centre axis 17 coincides with the transverse axis 18 of the front wall 12 or, as shown in FIG. 1, are mirror symmetrical to the transverse axis 18 of the front wall. It is possible to have several openings 15 in rows or in individually superimposed manner. The openings 15 can be in superimposed rows or also in irregular superimposed form. With the opening 15 the front side 19 of the front wall 12 forms a front edge 20. In the case of continuous castings the openings 15 can be formed by bores. The openings 15 are adapted to the shape of the water outlet nozzle 16 to be inserted, i.e. are preferably circular. Set back from the front portion 13 of the front wall 12 is provided a holder 21, which holds the water intake nozzle 16 and on which engage the retaining means. In the described embodiment the holder 21 is shaped in one piece with the front wall 12 and is in particular constructed during continuous casting. However, it is also possible to fix the holder to the front portion 13 of the front wall 12, particularly to its rear 22. In the described embodiment the holder 21 forms with the front portion of the front plate a closed chamber 23. However, other holder types are possible, e.g. two angle members on either side of the opening. The chamber 23 can also be opened on one side in the lateral direction of the front wall 12. On the rear 24 of the chamber 23 is provided an opening 25. As can be seen in FIG. 2, the opening 25 has a somewhat smaller diameter than the opening 15. A rear part of the water outlet nozzle 16 can be passed through the opening 25. As is shown on the left-hand side of FIG. 2, a circular projecting length is formed and its width corresponds to the difference of the radii of opening 15 and opening 25. This projecting length is constructed as an abutment 26 on which can be supported the water outlet nozzle 16, in the manner to be described hereinafter.

The circular ring shape of the projecting length is interrupted by two facing locking elements 40 diametral to the centre axis of the opening 17. The locking elements 40 are constructed as grooves and cooperate with complimentary constructed studs on the water outlet nozzle 16. However, other locking elements 40 are conceivable, e.g. a slit or the like.

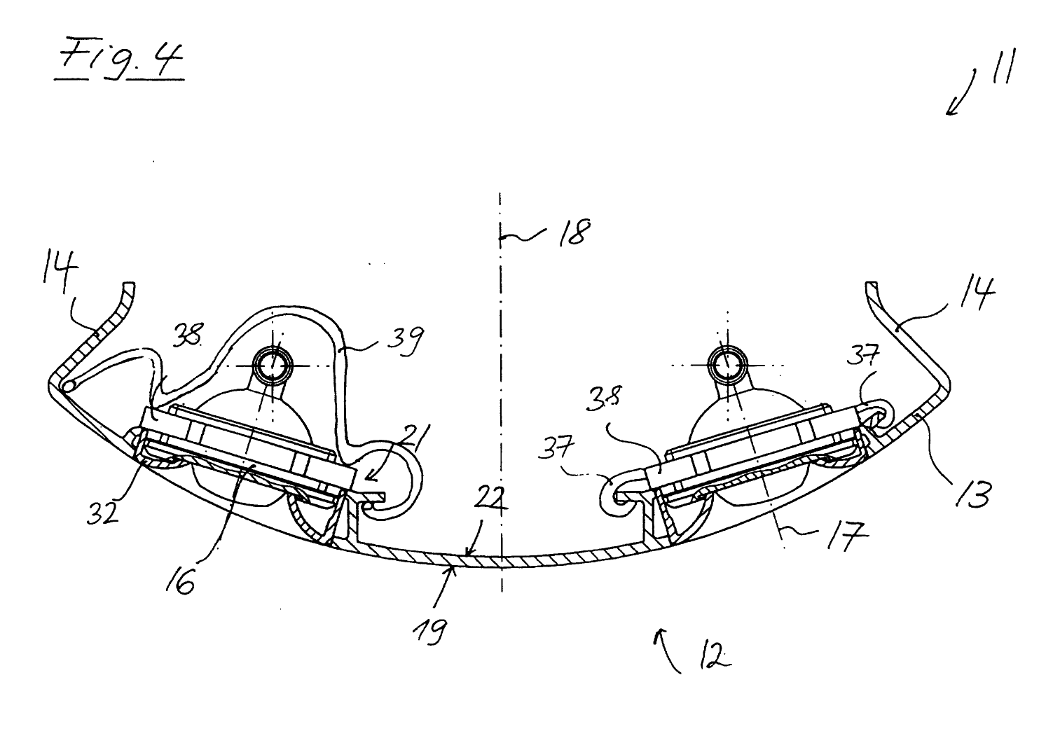

In order to ensure that the jet direction of the water outlet nozzle 16 does not move past but instead strikes the user, the chambers 23 are asymmetrically constructed. Whereas the front side of the chamber 23 coincides with part of the front portion 13 of the front wall and is curved, the rear 24 of the chamber 23 is flat or planar. The tangents on the curved front side of the chamber with the intersection of the centre axis 17 of the opening 15 and the front side as the intersection point and the rear 24 of the chamber 23 are at an angle to one another. In the embodiment shown in FIG. 1 said angle is e.g. 20°, so that the jet directions diverge less than corresponds to the front curvature. On the rear 24 of the chamber 23 can be formed a projection 27, as will be described in greater detail hereinafter and which can be used for fixing the water outlet nozzle 16. In the manner shown in FIG. 4, projections can be formed on either side of the rear 24 of the chamber 23.

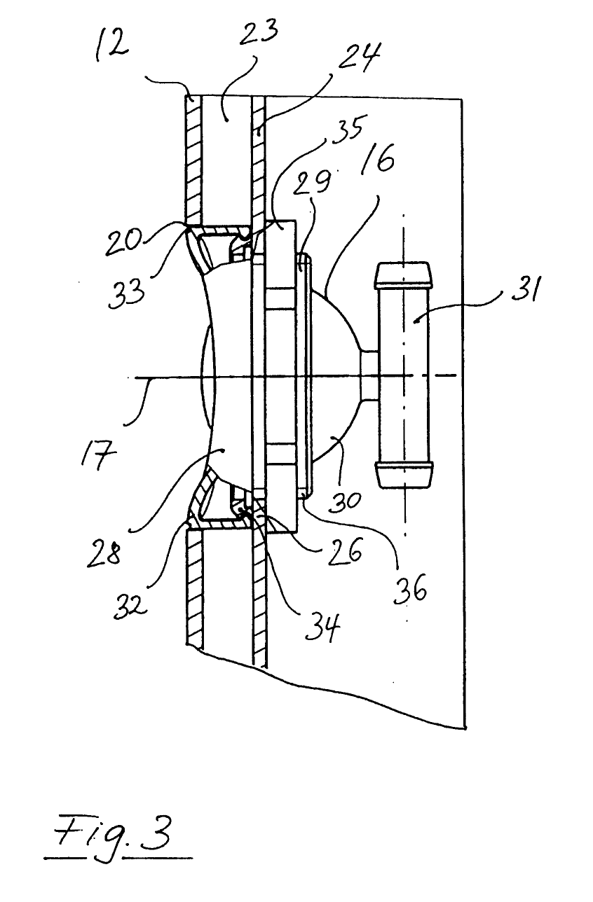

FIG. 3 shows a detail of the front wall 12 with a water outlet nozzle 16 secured in the opening 15. The water outlet nozzle in the embodiment described is a side shower, but can also be a bubble nozzle or steam nozzle. The side shower comprises a shower head 28, a retaining means portion 29, which passes into a transition 30, and a connecting piece 31 for a water hose. On its top the shower head 28 has a convex curvature. The outer contour of the shower head 28 can have different geometries and, in the manner shown in FIG. 3, can e.g. be stepped truncated cone-shaped. The shower head 28 can be turned in different directions. The retaining means portion 29, which is connected directly to the shower head 28, is preferably cylindrical. It can have a thread, onto which can be screwed a retaining means described hereinafter. Directly at the transition between the shower head and its retaining means portion 29 are provided two not shown, facing studs, which are diametral to the centre axis 17 of the opening 15, which engage in groove-like locking elements 40 and prevent the water outlet nozzle 16 from twisting in the opening 25. The transition connected to the retaining means portion 29 is constructed as a diffuser, which divides or splits up the inflowing water. The water flows in by means of a not shown hose via the connecting piece 31. The hose can be directly connected to a water source, but it is also possible for it to he coupled to another connecting piece of another water outlet nozzle.

In the described embodiment and as shown in FIGS. 3 and 4, a covering 32 is fixed to the water outlet nozzle 16. The covering is preferably a solid flange, which can be set off with respect to the material and colouring of the front wall 12. As can be seen in FIG. 3, the solid flange terminates roughly flush with the front side of the front portion 13 of the front wall 12. To prevent an overlap of the solid flange with the front edge 20 of the front side 19, a shadow gap 33 can be installed.

In the embodiment described the covering, i.e. the solid flange, is a component separate from the water outlet nozzle 16. Preferably, following the introduction of the water outlet nozzle into the opening 15 it is fitted thereto. For this purpose is provided a ring on the rear of the solid flange 32 and it engages in an undercut on the shower head 28. The dimensions of the covering are preferably such that it terminates flush with the front side of the front wall 12, i.e. the angle difference between the holder, i.e. in this case the rear wall of the chamber and the front wall 12 is compensated.

FIGS. 3 and 4 show the water outlet nozzle in its securing position in the opening 15 of the front wall 12. For the installation of the water outlet nozzle 16 it is initially passed from the front through the opening 15 until a flange 34 shaped on the shower head 28 comes into contact with the projecting length constructed as an abutment 26. Thus, the water outlet nozzle is prevented from any further movement in the sliding in direction. The retaining means portion 29 of the water outlet nozzle 16 projects through the opening 25 on the rear 24 of the chamber 23. The studs formed on the retaining means portion 29 prevent the water outlet nozzle from twisting or turning in the opening 25. The opening 25 prevents a longitudinal or transverse sliding of the water outlet nozzle 16. A counterpart 35 is provided to prevent the water outlet nozzle 16 from a movement counter to the sliding in direction, i.e. counter to an extraction from the opening 15. As shown in FIG. 3, the counterpart can be a nut, which is screwed onto a thread 36 on the retaining means portion 29 of the water outlet nozzle 16 and is supported on the rear 24 of the chamber 23. In the manner shown on the right-hand side of FIG. 4, it is also possible to introduce the water outlet nozzle 16 from the rear, the collar shaped on the water outlet nozzle being supported on the rear of the chamber 23. For securing the water outlet nozzle 16 it is possible to provide two facing springs diametral to the centre axis 17 of the opening 15 and which engage behind two projections shaped on the rear of the chamber 23. An alternative thereto is shown on the left-hand side of FIG. 4, where the collar 38 is fixed by means of a spring clip 39, which also engages behind a projection 27 on the holder 21.

1 sanitary device with at least one installed water outlet nozzle, particularly a shower element, the sanitary device having a front wall with a front side facing the user, on which is formed at least one opening forming with the front side a front edge, at least one water outlet nozzle being fixed by retaining means to a holder of the sanitary device, characterized in that the retaining means engage behind the front side (19) of the front wall (12) and the front edge (20) of the opening (15) is free from retaining means.

2. Sanitary device according to claim 1, characterized in that the water outlet nozzle (16) is inserted from the front through the opening (15).

3. Sanitary device according to claim 1 or 2, characterized in that the holders (21) are set back from the front side (19) of the front wall (12).

4. Sanitary device according to one of the preceding claims, characterized in that the holder (21) is shaped in one piece on the front wall (12) and is in particular moulded in one piece therewith.

5. Sanitary device according to one of the preceding claims, characterized in that the front wall (12) is a continuous casting.

6. Sanitary device according to one of the preceding claims, characterized in that the opening (15) is formed by a bore in the continuous casting.

7. Sanitary device according to one of the preceding claims, characterized in that the water outlet nozzle (16) is retained so as not to twist and slide in the holder (21).

8. Sanitary device according to one of the preceding claims, characterized in that the holder is asymmetrical with respect to the front wall, so that the direction of the water jets in the normal position is directed at an angle to the perpendicular on the front wall.

9. Sanitary device according to one of the preceding claims, characterized in that the holder (21) forms with the front wall (12) a chamber (23) and preferably the chamber (23) is closed on at least one side in the lateral direction of the front wall (12).

10. Sanitary device according to claim 9, characterized in that the chamber (23) passes over the entire length of the front wall (12), particularly the continuous casting and preferably at both ends forms an open termination with the front wall (12).

11. Sanitary device according to claim 9 or 10, characterized in that the front wall (12) is curved perpendicular to its longitudinal direction and the rear of the chamber (23) is planar.

12. Sanitary device according to one of the preceding claims, characterized in that the holder (21) is an abutment (26) for fixing the water outlet nozzle (16) in the opening (15).

13. Sanitary device according to one of the preceding claims, characterized in that the retaining means are formed by a flange (34) of the water outlet nozzle (16) and a counterpart (35) and which preferably embrace on either side the holder (21).

14. Sanitary device according to one of the preceding claims, characterized in that the counterpart (35) is a nut, which is screwed on a thread (36) of the water outlet nozzle (16).

15. Sanitary device according to one of the preceding claims, characterized in that the holder has at least one locking element to prevent the turning of the water outlet nozzle (16), the locking element preferably being constructed as a groove, more particularly as two facing grooves diametral to the centre axis (17) of the opening (15) and in which engages a complimentary stud, particularly two studs of the water outlet nozzle.

16. Sanitary device according to one of the preceding claims, characterized in that the water outlet nozzle (16) is provided with a covering (32), particularly a solid flange, the covering terminating substantially flush with the front side (19) of the front wall (12).

17. Sanitary device according to claim 16, characterized in that the covering is preferably detachably fixed to the water outlet nozzle (16), being connected to rotate together with the water outlet nozzle (16).
